(19) United States
(12) Patent Application Publication
(10) Pub. No.: US 2013/0235088 A1
(43) Pub. Date: Sep. 12, 2013

(54) DEVICE, METHOD, AND STORAGE MEDIUM STORING PROGRAM

(71) Applicant: KYOCERA CORPORATION, Kyoto-shi (JP)

(72) Inventor: Hiroaki MIURA, Yokohama-shi (JP)

(73) Assignee: KYOCERA CORPORATION, Kyoto-shi (JP)

(21) Appl. No.: 13/788,632

(22) Filed: Mar. 7, 2013

(30) Foreign Application Priority Data
Mar. 8, 2012 (JP) 2012-051682

(51) Int. Cl. G09G 5/34

(52) U.S. Cl. CPC G09G 5/34
USPC 345/684

(57) ABSTRACT

According to an aspect, a device includes a touch screen display and a controller. The touch screen display displays a screen including a plurality of pieces of information. When scrolling the screen, the controller controls speed of scrolling the screen according to an attribute of the piece of the information displayed on the touch screen display.

### CROSS-REFERENCE TO RELATED APPLICATIONS

This application claims priority from Japanese Application No. 2012-051682, filed on Mar. 8, 2012, the content of which is incorporated by reference herein in its entirety.

### BACKGROUND

1. Technical Field

The present application relates to a device, a method, and a storage medium storing therein a program. More particularly, the present application relates to a device including a touch screen, a method of controlling the device, and a storage medium storing therein a program for controlling the device.

2. Description of the Related Art

A touch screen device having a touch screen has been known. Examples of the touch screen devices include, but are not limited to, a smartphone and a tablet. The touch screen device detects a gesture of a finger, a pen, or a stylus pen through the touch screen. Then, the touch screen device operates according to the detected gesture. An example of the operation according to the detected gesture is described in, for example, International Publication Pamphlet No. 2008/086302.

The basic operation of the touch screen device is implemented by an operating system (OS) built into the device. Examples of the OS built into the touch screen device include, but are not limited to, Android, BlackBerry OS, iOS, Symbian OS, and Windows Phone.

Most of touch screen devices display a list including items each corresponding to each of pieces of information on a touch screen. The touch screen device scrolls a screen that displays the list according to a user's operation so that the user can view all the items in the list. The touch screen device starts scrolling the screen according to the user's operation, gradually decreases the speed of the scrolling, and finally stops the scrolling. When scrolling the screen, the user may overlook information or may take some time to reach desired information.

For the foregoing reasons, there is a need for a device, a method, and a program capable of improving operability of screen scrolling.

### SUMMARY

According to an aspect, a device includes a touch screen display and a controller. The touch screen display displays a screen including a plurality of pieces of information. When scrolling the screen, the controller controls speed of scrolling the screen according to an attribute of the piece of the information displayed on the touch screen display.

According to another aspect, a method is for controlling a device having a touch screen display. The method includes: displaying a screen including a plurality of pieces of information on the touch screen display; and controlling, upon scrolling the screen, speed of scrolling the screen according to an attribute of the piece of information displayed on the touch screen display.

According to another aspect, a non-transitory storage medium stores a control program. When executed by a device having a touch screen display, the program causes the device to execute: displaying a screen including a plurality of pieces of information on the touch screen display; and controlling, upon scrolling the screen, speed of scrolling the screen according to an attribute of the piece of information displayed on the touch screen display.

### BRIEF DESCRIPTION OF THE DRAWINGS

FIG. 1 is a perspective view of a smartphone according to an embodiment;

FIG. 2 is a front view of the smartphone;

FIG. 3 is a back view of the smartphone;

FIG. 4 is a diagram illustrating an example of a home screen;

FIG. 5 is a diagram illustrating an example of a screen when an inbox for e-mails is displayed on a display;

FIG. 6 is a diagram illustrating an example of a screen when the WEB page is displayed on the display;

FIG. 7 is a diagram illustrating an example of the screen when a WEB page is displayed on the display;

FIG. 8 is a block diagram illustrating a configuration of the smartphone according to the embodiment;

FIG. 9 is a diagram illustrating an example of control in a case where a screen scrolling operation is detected through a touch screen while the screen of the inbox is displayed on the display;

FIG. 10 is a diagram illustrating another example of the control in a case where a screen scrolling operation is detected through the touch screen while the screen of the inbox is displayed on the display;

FIG. 11 is a diagram illustrating another example of the control in a case where a screen scrolling operation is detected through the touch screen while the screen of the inbox is displayed on the display;

FIG. 12 is a diagram illustrating an example of control in a case where a screen scrolling operation is performed while the screen of the WEB page is displayed on the display; and

FIG. 13 is a diagram illustrating a procedure for controlling the speed of scrolling the screen according to an attribute of information displayed on the display in a case a screen scrolling operation is detected through the touch screen.

### DETAILED DESCRIPTION

Exemplary embodiments will be explained in detail below with reference to the accompanying drawings. A smartphone will be explained below as an example of a device provided with a touch screen.

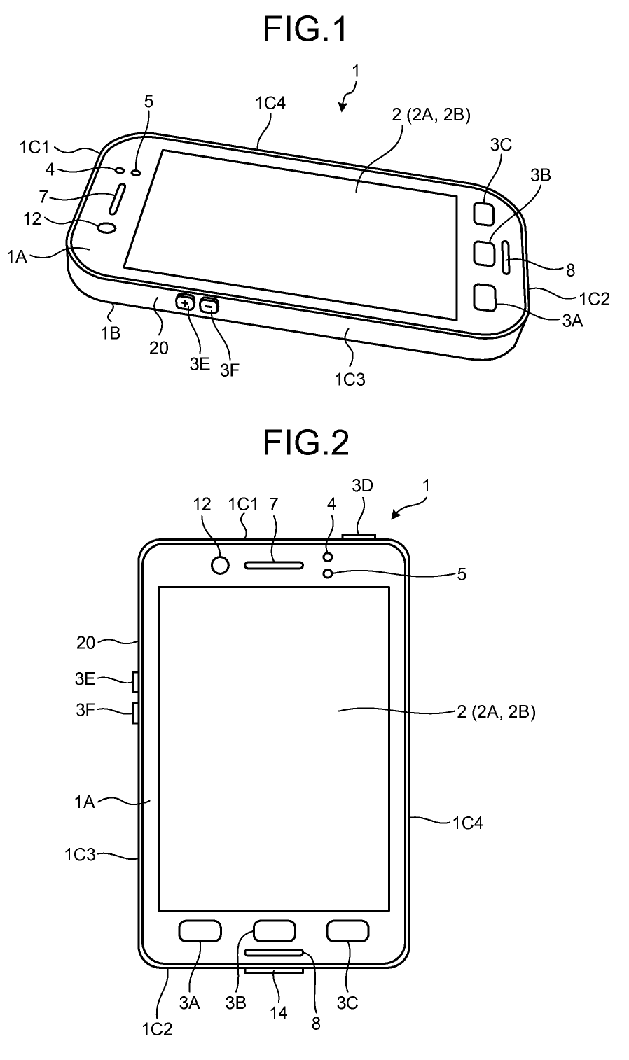

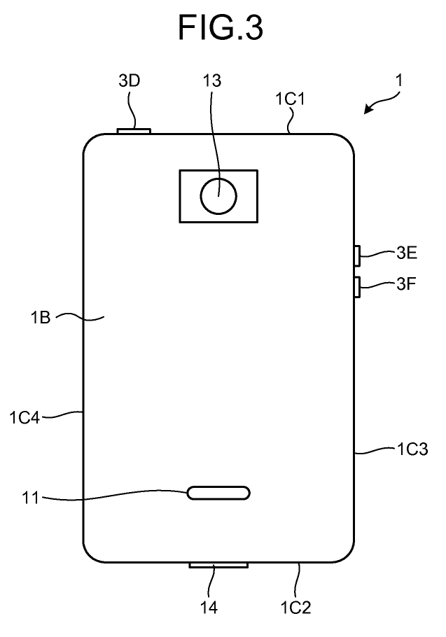

An overall configuration of a smartphone 1 according to an embodiment will be explained below with reference to FIG. 1 to FIG. 3. As illustrated in FIG. 1 to FIG. 3, the smartphone 1 includes a housing 20. The housing 20 includes a front face 1A, a back face 1B, and side faces 1C1 to 1C4. The front face 1A is a front of the housing 20. The back face 1B is a back of the housing 20. The side faces 1C1 to 1C4 are sides each connecting the front face 1A and the back face 1B. Hereinafter, the side faces 1C1 to 1C4 may be collectively called “side face 1C” without being specific to any of the side faces.

The smartphone 1 includes a touch screen display 2, buttons 3A to 3C, an illumination (ambient light) sensor 4, a proximity sensor 5, a receiver 7, a microphone 8, and a camera 12, which are provided in the front face 1A. The smartphone 1 includes a speaker 11 and a camera 13, which are provided in the back face 1B. The smartphone 1 includes buttons 3D to 3F and a connector 14, which are provided in the side face 1C. Hereinafter, the buttons 3A to 3F may be collectively called “button 3” without being specific to any of the buttons.

The touch screen display 2 includes a display 2A and a touch screen 2B. In the example of FIG. 1, each of the display 2A and the touch screen 2B is approximately rectangular-shaped; however, the shapes of the display 2A and the touch screen 2B are not limited thereto. Each of the display 2A and the touch screen 2B may have any shape such as a square, a circle or the like. In the example of FIG. 1, the display 2A and the touch screen 2B are arranged in a superimposed manner; however, the manner in which the display 2A and the touch screen 2B are arranged is not limited thereto. The display 2A and the touch screen 2B may be arranged, for example, side by side or apart from each other. In the example of FIG. 1, longer sides of the display 2A are along with longer sides of the touch screen 2B respectively while shorter sides of the display 2A are along with shorter sides of the touch screen 2B respectively; however, the manner in which the display 2A and the touch screen 2B are superimposed is not limited thereto. In case the display 2A and the touch screen 2B are arranged in the superimposed manner, they can be arranged such that, for example, one or more sides of the display 2A are not along with any sides of the touch screen 2B.

The display 2A is provided with a display device such as a liquid crystal display (LCD), an organic electro-luminescence display (GELD), or an inorganic electro-luminescence display (IELD). The display 2A displays text, images, symbols, graphics, and the like.

The touch screen 2B detects a contact of a finger, a pen, a stylus pen, or the like on the touch screen 2B. The touch screen 2B can detect positions where a plurality of fingers, pens, stylus pens, or the like make contact with the touch screen 2B.

The detection method of the touch screen 2B may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. In the description herein below, for the sake of simplicity, it is assumed that the user uses his/her finger(s) to make contact with the touch screen 2B in order to operate the smartphone 1.

The smartphone 1 determines a type of a gesture based on at least one of a contact detected by the touch screen 2B, a position where the contact is detected, a change of a position where the contact is detected, an interval between detected contacts, and the number of detection times of the contact. The gesture is an operation performed on the touch screen 2B. Examples of the gestures determined by the smartphone 1 include, but are not limited to, touch, long touch, release, swipe, tap, double tap, long tap, drag, flick, pinch in, and pinch out.

“Touch” is a gesture in which a finger makes contact with the touch screen 2B. The smartphone 1 determines a gesture in which the finger makes contact with the touch screen 2B as touch. “Long touch” is a gesture in which a finger makes contact with the touch screen 2B for longer than a given time. The smartphone 1 determines a gesture in which the finger makes contact with the touch screen 2B for longer than a given time as long touch.

“Release” is a gesture in which a finger separates from the touch screen 2B. The smartphone 1 determines a gesture in which the finger separates from the touch screen 2B as release. “Swipe” is a gesture in which a finger moves on the touch screen 2B with continuous contact thereon. The smartphone 1 determines a gesture in which the finger moves on the touch screen 2B with continuous contact thereon as swipe.

“Tap” is a gesture in which a touch is followed by a release. The smartphone 1 determines a gesture in which a touch is followed by a release as tap. “Double tap” is a gesture such that a gesture in which a touch is followed by a release is successively performed twice. The smartphone 1 determines a gesture such that a gesture in which a touch is followed by a release is successively performed twice as double tap.

“Long tap” is a gesture in which a long touch is followed by a release. The smartphone 1 determines a gesture in which a long touch is followed by a release as long tap. “Drag” is a gesture in which a swipe is performed from an area where a movable-object is displayed. The smartphone 1 determines a gesture in which a swipe is performed from an area where the movable-object displayed as drag.

“Flick” is a gesture in which a finger separates from the touch screen 2B while moving after making contact with the touch screen 2B. That is, “Flick” is a gesture in which a touch is followed by a release accompanied with a movement of the finger. The smartphone 1 determines a gesture in which the finger separates from the touch screen 2B while moving after making contact with the touch screen 2B as flick. The flick is performed, in many cases, with a finger moving along one direction. The flick includes “upward flick” in which the finger moves upward on the screen, “downward flick” in which the finger moves downward on the screen, “rightward flick” in which the finger moves rightward on the screen, and “leftward flick” in which the finger moves leftward on the screen, and the like. Movement of the finger during the flick is, in many cases, quicker than that of the finger during the swipe.

“Pinch in” is a gesture in which a swipe with a plurality of fingers is performed in a direction to move the fingers toward each other. The smartphone 1 determines a gesture in which the distance between a position of one finger and a position of another finger detected by the touch screen 2B becomes shorter as pinch in. “Pinch out” is a gesture in which a swipe with a plurality of fingers is performed in a direction to move the fingers away from each other. The smartphone 1 determines a gesture in which the distance between a position of one finger and a position of another finger detected by the touch screen 2B becomes longer as pinch out.

The smartphone 1 performs operations according to these gestures which are determined through the touch screen 2B. Therefore, user-friendly and intuitive operability is achieved. The operations performed by the smartphone 1 according to the determined gestures may be different depending on the screen displayed on the display 2A. In the following explanation, for the sake of simplicity of explanation, the fact that the touch screen detects the contact(s) and then the smartphone determines the type of the gesture as X based on the contact(s) may be simply described as “the smartphone detects X”, “the controller detects X”, “the touch screen detects X”, or “the touch screen display detects X”.

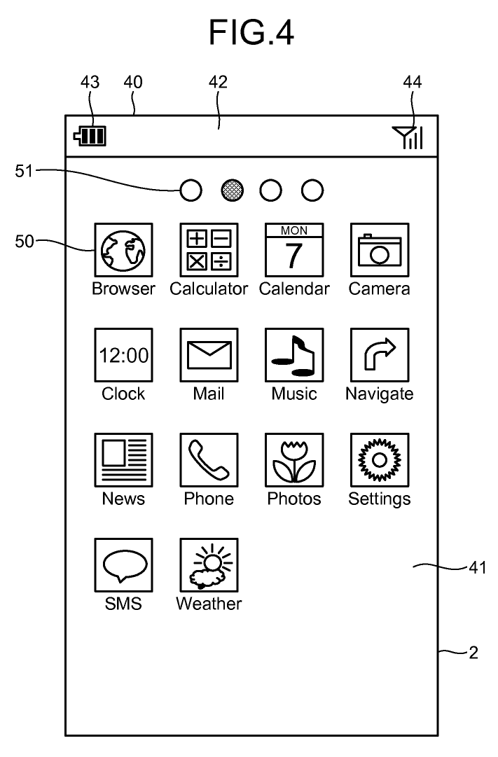

An example of the screen displayed on the display 2A will be explained below with reference to FIG. 4. FIG. 4 represents an example of a home screen. The home screen may also be called “desktop”, “standby screen”, “idle screen”, or “standard screen”. The home screen is displayed on the display 2A. The home screen is a screen allowing the user to select which one of applications (programs) installed in the smartphone 1 is executed. The smartphone 1 executes the application selected on the home screen in the foreground. The screen of the application executed in the foreground is displayed on the display 2A.

Icons can be arranged on the home screen of the smartphone 1. A plurality of icons 50 are arranged on a home screen 40 illustrated in FIG. 4. Each of the icons 50 is previously associated with an application installed in the smartphone 1. When detecting a gesture for an icon 50, the smartphone 1 executes the application associated with the icon 50 for which the gesture is detected. For example, when detecting a tap on an icon 50 associated with a mail application, the smartphone 1 executes the mail application.

The icons 50 include an image and a character string. The icons 50 may contain a symbol or a graphic instead of an image. The icons 50 do not have to include either one of the image and the character string. The icons 50 are arranged based on a layout pattern. A wall paper 41 is displayed behind the icons 50. The wall paper may sometimes be called “photo screen”, “back screen”, “idle image”, or “background image”. The smartphone 1 can use an arbitrary image as the wall paper 41. The smartphone 1 may be configured so that the user can select an image to be displayed as the wall paper 41.

The smartphone 1 can include a plurality of home screens. The smartphone 1 determines, for example, the number of home screens according to setting by the user. The smartphone 1 displays a selected one on the display 2A even if there is a plurality of home screens.

The smartphone 1 displays an indicator (a locator) 51 on the home screen. The indicator 51 includes one or more symbols. The number of the symbols is the same as that of the home screens. In the indicator 51, a symbol corresponding to a home screen that is currently displayed is displayed in a different manner from that of symbols corresponding to the other home screens.

The indicator 51 in an example illustrated in FIG. 4 includes four symbols. This means the number of home screens is four. According to the indicator 51 in the example illustrated in FIG. 4, the second symbol from the left is displayed in a different manner from that of the other symbols. This means that the second home screen from the left is currently displayed.

The smartphone 1 can change a home screen to be displayed on the display 2A. When a gesture is detected while displaying one of home screens, the smartphone 1 changes the home screen to be displayed on the display 2A to another one. For example, when detecting a rightward flick, the smartphone 1 changes the home screen to be displayed on the display 2A to a home screen on the left side. For example, when detecting a leftward flick, the smartphone 1 changes the home screen to be displayed on the display 2A to a home screen on the right side. The smartphone 1 changes the home screen to be displayed on the display 2A from a first home screen to a second home screen, when a gesture is detected while displaying the first home screen, such that the area of the first home screen displayed on the display 2A gradually becomes smaller and the area of the second home screen displayed gradually becomes larger. The smartphone 1 may switch the home screens such that the first home screen is instantly replaced by the second home screen.

An area 42 is provided along the top edge of the display 2A. Displayed on the area 42 are a remaining mark 43 indicating a remaining amount of a power supply and a radio-wave level mark 44 indicating an electric field strength of radio wave for communication. The smartphone 1 may display time, weather, an application during execution thereof, a type of communication system, a status of a phone call, a mode of the device, an event occurring in the device, and the like in the area 42. In this manner, the area 42 is used to inform the user of various notifications. The area 42 may be provided on any screen other than the home screen 40. A position where the area 42 is provided is not limited to the top edge of the display 2A.

The home screen 40 illustrated in FIG. 4 is only an example, and therefore the configuration of each of elements, the arrangement of the elements, the number of home screens 40, the way to perform each of operations on the home screen 40, and the like do not have to be like the above mentioned explanation.

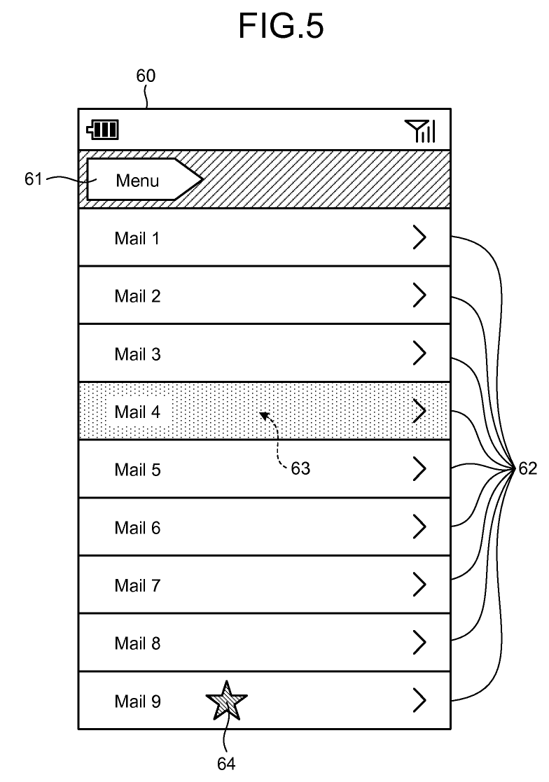

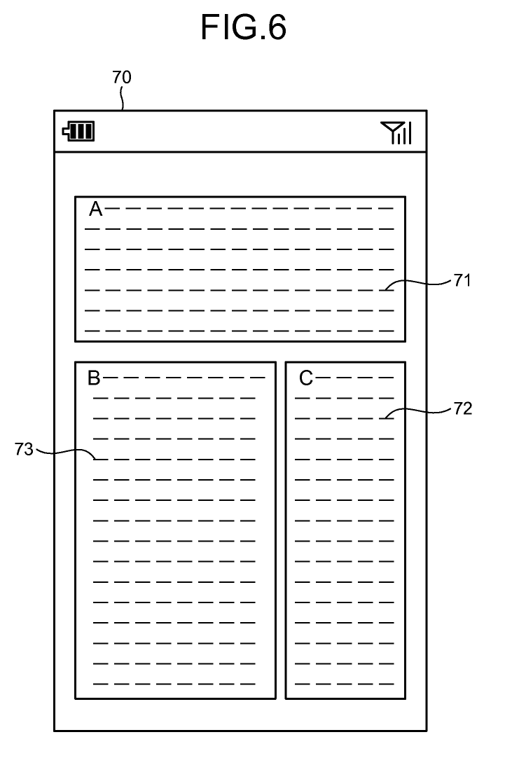

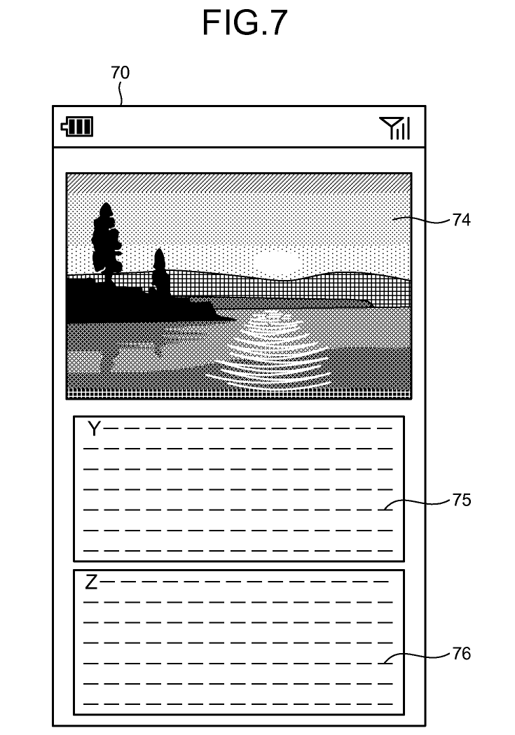

Examples of the screen displayed on the display 2A will be explained below with reference to FIG. 5, FIG. 6, and FIG. 7. The smartphone 1 displays a screen 60 illustrated in FIG. 5 or a screen 70 illustrated in FIG. 6 and FIG. 7 on the display 2A as well as the home screen 40 illustrated in FIG. 4.

FIG. 5 represents an example of the screen when an inbox for e-mails is displayed on the display 2A. The screen 60 illustrated in FIG. 5 includes a menu button 61, a plurality of items 62, and a mark 64. The menu button 61 is operated by the user when making various setting related to incoming mails. The item 62 is provided for each of received e-mails. The items 62 corresponding to mails 1 to 3 and mails 5 to 9 correspond to e-mails whose bodies have been displayed on the display 2A. The item 62 corresponding to a mail 4 corresponds to an e-mail whose body has never been displayed on the display 2A. In the description below, the incoming mail, such as the mails 1 to 3 and the mails 5 to 9, whose body has been displayed on the display 2A may be called a read mail, and the incoming mail, such as the mail 4, whose body has never been displayed on the display 2A may be called an unread mail. For example, as illustrated in FIG. 5, the smartphone 1 displays the item 62 corresponding to the mail 4 being the unread mail in a color 63 different from that of the read mails. The mark 64 is attached to the item 62. For example, when receiving a selection of a mail to be attached with the mark 64 from among the read mails from the user, the smartphone 1 attaches an image of the mark 64 to the item 62. The smartphone 1 may change a display mode of the item according to an attribute of the incoming mail in such a manner that the item 62 corresponding to the unread mail is displayed in the color different from that of the read mail as indicated by the color 63 in FIG. 5, the mark 64 is attached to the read mail selected by the user, and the like. This enables the user to easily visually recognize the unread mail and the mail selected by the user. Examples of the attribute of the incoming mail include, but not limited to, a field of a mail header and its value, body of the mail, and values stored in a database (repository) for managing whether the mail has been read, whether a reply has been sent, and whether the mail has been selected by the user.

FIG. 6 and FIG. 7 represent examples of the screen when a WEB page is displayed on the display 2A. The WEB page illustrated in FIG. 6 and FIG. 7 forms a continuous page that can be viewed by scrolling the screen. In other words, the WEB page illustrated in FIG. 6 and FIG. 7 is displayed based on a piece of the HyperText Markup Language (HTML) form data and other pieces of data, such as image data, referred to by the HTML data. The screen 70 illustrated in FIG. 6 includes text data 71, text data 72, and text data 73. The screen 70 illustrated in FIG. 7 includes image data 74, text data 75, and text data 76.

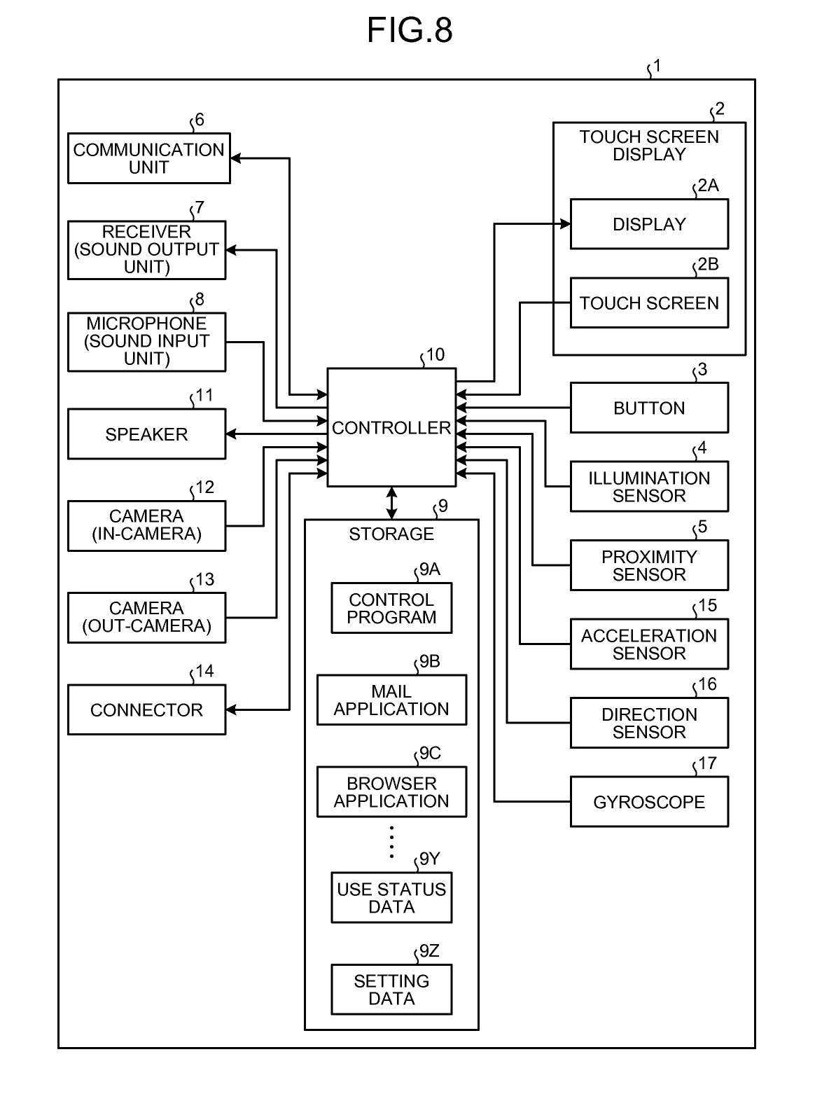

FIG. 8 is a block diagram of the smartphone 1. The smartphone 1 includes the touch screen display 2, the button 3, the illumination sensor 4, the proximity sensor 5, a communication unit 6, the receiver 7, the microphone 8, a storage 9, a controller 10, the speaker 11, the cameras 12 and 13, the connector 14, an acceleration sensor 15, a direction (orientation) sensor 16, and a gyroscope 17.

The touch screen display 2 includes, as explained above, the display 2A and the touch screen 2B. The display 2A displays text, images, symbols, graphics, or the like. The touch screen 2B detects contact(s). The controller 10 detects an operation (a gesture) for the touch screen 2B in cooperation with the touch screen 2B.

The button 3 is operated by the user. The button 3 includes buttons 3A to 3F. The controller 10 detects an operation for the button 3 in cooperation with the button 3. Examples of the operations for the button 3 include, but are not limited to, a click, a double click, a triple click, a push, and a multi-push.

The buttons 3A to 3C are, for example, a home button, a back button, or a menu button. The button 3D is, for example, a power on/off button of the smartphone 1. The button 3D may function also as a sleep/sleep release button. The buttons 3E and 3F are, for example, volume buttons.

The illumination sensor 4 detects illumination of the ambient light of the smartphone 1. The illumination indicates intensity of light, lightness, or brightness. The illumination sensor 4 is used, for example, to adjust the brightness of the display 2A. The proximity sensor 5 detects the presence of a nearby object without any physical contact. The proximity sensor 5 detects the presence of the object based on a change of the magnetic field, a change of the return time of the reflected ultrasonic wave, etc. The proximity sensor 5 detects the presence of the nearby object, for example, when the touch screen display 2 is brought close to someone's face. The illumination sensor 4 and the proximity sensor 5 may be configured as one sensor. The illumination sensor 4 can be used as a proximity sensor.

The communication unit 6 performs communication via radio waves. A communication system supported by the communication unit 6 is wireless communication standard. The wireless communication standard includes, for example, a communication standard of cellar phones such as 2G, 3G, and 4G. The communication standard of cellar phones includes, for example, Long Term Evolution (LTE), Wideband Code Division Multiple Access (W-CDMA), CDMA 2000, a Personal Digital Cellular (PDC), a Global System for Mobile Communications (GSM), and a Personal Handy-phone System (PHS). The wireless communication standard further includes, for example, Worldwide Interoperability for Microwave Access (WiMAX), IEEE 802.11, Bluetooth, Infrared Data Association (IrDA), and Near Field Communication (NFC). The communication unit 6 may support one or more communication standards.

The receiver 7 and the speaker 11 are sound output units. The receiver 7 and the speaker 11 output a sound signal transmitted from the controller 10 as sound. The receiver 7 is used, for example, to output voice of the other party on the phone. The speaker 11 is used, for example, to output a ring tone and music. Either one of the receiver 7 and the speaker 11 may double as the other function. The microphone 8 is a sound input unit. The microphone 8 converts speech of the user or the like to a sound signal and transmit the converted signal to the controller 10.

The storage 9 stores therein programs and data. The storage 9 is used also as a work area that temporarily stores a processing result of the controller 10. The storage 9 may include any non-transitory storage medium such as a semiconductor storage medium and a magnetic storage medium. The storage 9 may include a plurality type of storage mediums. The storage 9 may include a combination of a portable storage medium such as a memory card, an optical disc, or a magneto-optical disc with a reader of the storage medium. The storage 9 may include a storage device used as a temporary storage area such as Random Access Memory (RAM).

Programs stored in the storage 9 include applications executed in the foreground or the background and a control program for assisting operations of the applications. The application causes the controller 10, for example, to display a screen on the display 2A and perform a process according to a gesture detected through the touch screen 2B. The control program is, for example, an OS. The applications and the control program may be installed in the storage 9 through communication by the communication unit 6 or through a non-transitory storage medium.

The storage 9 stores therein, for example, a control program 9A, a mail application 9B, a browser application 9C, use status data 9Y, and setting data 9Z. The mail application 9B provides an e-mail function for composing, transmitting, receiving, and displaying e-mail, and the like. The browser application 9C provides a WEB browsing function for displaying WEB pages and editing bookmarks, or the like. The use status data 9Y contains information related to use statuses of applications installed into the smartphone 1. For example, the use status data 9Y includes items such as Screen, Row, Column, Image, Name, Installation Date/Time, Usage, and Last Use Date/Time, and holds data for each application installed into the smartphone 1. The setting data 9Z contains information related to various settings on the operations of the smartphone 1. For example, the setting data 9Z includes setting conditions for controlling the screen displayed on the display 2A. The setting conditions include, for example, a control for screen scrolling so as to display the item 62 corresponding to an unread mail at a specific position in the inbox, and a control for screen scrolling so as to display an item corresponding to an unread mail newly appearing on the screen 60 of the inbox through scrolling at a specific position in the inbox. Alternatively, the setting conditions include a control for screen scrolling so as to display, for example, when an item 62 attached with the mark 64 newly appears on the screen 60 of the inbox through scrolling, the item 62 at a specific position in the inbox. Alternatively, the setting conditions include a control for screen scrolling so as to display, for example, the image data 74 newly appearing on the screen 70 of the WEB page through scrolling at a specific position in the WEB page.

The control program 9A provides a function related to various controls for operating the smartphone 1. The control program 9A controls, for example, the communication unit 6, the receiver 7, and the microphone 8 to make a phone call. The function provided by the control program 9A includes a function for controlling, when a screen scrolling operation is detected through the touch screen 2B, the speed of scrolling the screen according to the attribute of information displayed on the display 2A. The information displayed on the display 2A includes information currently displayed on the display 2A and information to be displayed on the display through screen scrolling. The functions provided by the control program 9A can be used in combination with a function provided by the other program such as the mail application 9B.

The controller 10 is a processing unit. Examples of the processing units include, but are not limited to, a Central Processing Unit (CPU), System-on-a-chip (SoC), a Micro Control Unit (MCU), and a Field-Programmable Gate Array (FPGA). The controller 10 integrally controls the operations of the smartphone 1 to implement various functions.

Specifically, the controller 10 executes instructions contained in the program stored in the storage 9 while referring to the data stored in the storage 9 as necessary. The controller 10 controls a function unit according to the data and the instructions to thereby implement the various functions. Examples of the function units include, but are not limited to, the display 2A, the communication unit 6, the receiver 7, and the speaker 11. The controller 10 can change the control of the function unit according to the detection result of a detector. Examples of the detectors include, but are not limited to, the touch screen 2B, the button 3, the illumination sensor 4, the proximity sensor 5, the microphone 8, the camera 12, the camera 13, the acceleration sensor 15, the direction sensor 16, and the gyroscope 17.

The controller 10 executes, for example, the control program 9A to thereby control, when a screen scrolling operation is detected through the touch screen 2B, the speed of scrolling the screen according to the attribute of information displayed on the display 2A.

The camera 12 is an in-camera for photographing an object facing the front face 1A. The camera 13 is an out-camera for photographing an object facing the back face 1B.

The connector 14 is a terminal to which other device is connected. The connector 14 may be a general-purpose terminal such as a Universal Serial Bus (USB), a High-Definition Multimedia Interface (HDMI), Light Peak (Thunderbolt), and an earphone/microphone connector. The connector 14 may be a dedicated terminal such as a dock connector. Examples of the devices connected to the connector 14 include, but are not limited to, an external storage device, a speaker, and a communication device.

The acceleration sensor 15 detects a direction and a magnitude of acceleration applied to the smartphone 1. The direction sensor 16 detects a direction of geomagnetism. The gyroscope 17 detects an angle and an angular velocity of the smartphone 1. The detection results of the acceleration sensor 15, the direction sensor 16, and the gyroscope 17 are used in combination with each other in order to detect a position of the smartphone 1 and a change of its attitude.

Part or all of the programs and the data stored in the storage 9 in FIG. 8 may be downloaded from any other device through communication by the communication unit 6. Part or all of the programs and the data stored in the storage 9 in FIG. 8 may be stored in the non-transitory storage medium that can be read by the reader included in the storage 9. Part or all of the programs and the data stored in the storage 9 in FIG. 8 may be stored in the non-transitory storage medium that can be read by a reader connected to the connector 14. Examples of the non-transitory storage mediums include, but are not limited to, an optical disc such as CD, DVD, and Blu-ray, a magneto-optical disc, magnetic storage medium, a memory card, and solid-state storage medium.

The configuration of the smartphone 1 illustrated in FIG. 8 is only an example, and therefore it can be modified as required within a scope that does not depart from the gist of the present invention. For example, the number and the type of the button 3 are not limited to the example of FIG. 8. The smartphone 1 may be provided with buttons of a numeric keypad layout or a QWERTY layout and so on as buttons for operation of the screen instead of the buttons 3A to 3C. The smartphone 1 may be provided with only one button to operate the screen, or with no button. In the example of FIG. 8, the smartphone 1 is provided with two cameras; however, the smartphone 1 may be provided with only one camera or with no camera. In the example of FIG. 8, the smartphone 1 is provided with three types of sensors in order to detect its position and attitude; however, the smartphone 1 does not have to be provided with some of the sensors. Alternatively, the smartphone 1 may be provided with any other type of sensor for detecting at least one of the position and the attitude.

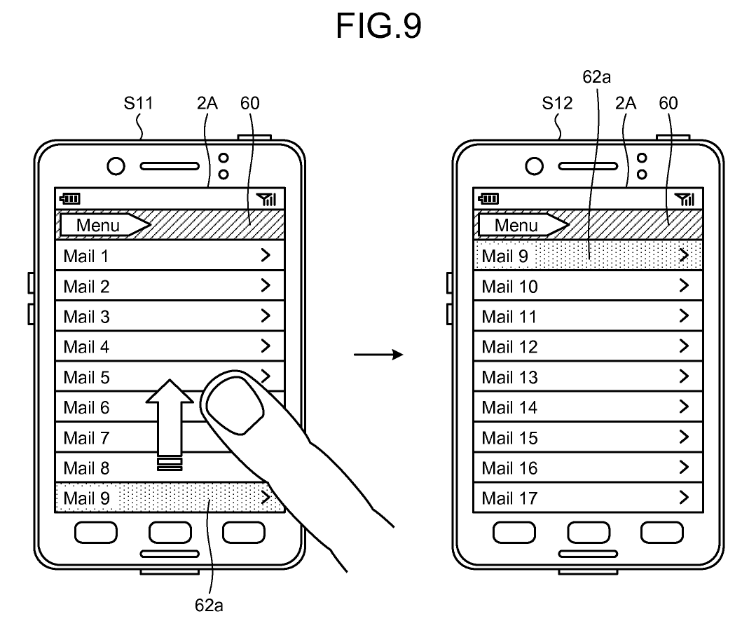

Examples of the control based on the functions provided by the control program 9A will be explained below with reference to FIG. 9 to FIG. 12. The functions provided by the control program 9A include a function for controlling, when a screen scrolling operation is detected through the touch screen 2B, the speed of scrolling the screen according to the attribute of information displayed on the display 2A. The examples of the scrolling operation include user's touch gestures such as flick, tap, double tap, or long touch.

FIG. 9 is an example of control in a case where a scrolling operation is performed for the screen 60 while the screen 60 of the inbox is displayed on the display 2A. At Step S11, the inbox including an item 62a corresponding to an unread mail is displayed on the display 2A, and a user's right index finger touches the screen 60. At Step S12, the display position of the item 62a in the inbox is changed by scrolling the screen 60.

The smartphone 1 acquires a detection result of the touch screen 2B, and, when detecting an upward flick, scrolls up the screen 60 of the inbox displayed on the display 2A. The smartphone 1 starts scrolling the screen 60 at a speed according to the speed (acceleration) of the flick (hereinafter also called a “normal speed”). The smartphone 1 may gradually decrease the speed of the scrolling started at the normal speed. Subsequently, the smartphone 1 controls the speed of scrolling the screen 60 according to the setting conditions included in the setting data 9Z, for example, so as to display the item 62a corresponding to the unread mail at the top of the inbox. For example, the smartphone 1 stops the scrolling at a timing at which the item 62a corresponding to the unread mail reaches the top of the inbox. Alternatively, the smartphone 1 adjusts the initial speed of the scrolling and a decrease rate of the speed thereof so that the speed of the scrolling gradually decreases as the item 62a corresponding to the unread mail approaches the top of the inbox and becomes zero at the timing at which the item 62a reaches the top of the inbox. In a case where the initial speed of the scrolling and the decrease rate of the speed thereof are adjusted, the smartphone 1 may control scrolling the screen when the item 62a corresponding to the unread mail is outside the screen 60 (i.e., when the item 62a is not displayed), such that the screen 60 is scrolled at the normal speed until the item 62a corresponding to the unread mail enters the screen 60 (i.e., until the item 62a is displayed), and, once the item 62a enters the screen 60, the decrease rate of the speed of the scrolling is adjusted so that the item 62a corresponding to the unread mail stops at the top of the inbox.

As illustrated in FIG. 9, when detecting an upward flick, the smartphone 1 scrolls the screen 60 of the inbox displayed on the display 2A. The smartphone 1 then refers to the setting conditions and stops scrolling when the item 62a corresponding to the unread mail reaches the top of the inbox. That is, the smartphone 1 allows the user to change the display position of an item corresponding to an unread mail, among the items 62 included in the inbox, with the user's simple touch gesture. Thus, according to the present embodiment, it is possible to improve the operability of screen scrolling.

Referring to FIG. 9, the example has been explained in which the smartphone 1 scrolls the screen 60 upon detecting the upward flick and then controls the speed of scrolling the screen 60 so as to stop the unread mail at the top of the inbox according to the setting conditions; however, the control of scrolling the screen is not limited thereto. For example, when detecting a flick in an upward direction (hereinafter also called a “upward flick”), the smartphone 1 may scroll the screen 60 and then control scrolling, for example, so as to stop the unread mail at the bottom of the inbox according to the setting conditions.

Referring to FIG. 9, the example has been explained in which the smartphone 1 controls the speed of scrolling the screen 60 so as to stop the item 62a corresponding to the unread mail at the top of the inbox; however, the control of scrolling the screen is not limited thereto. For example, when detecting a touch performed for the screen 60 during scrolling the screen 60, the smartphone 1 may stop scrolling the screen 60. Thus, the smartphone 1 can prioritize the user's operation.

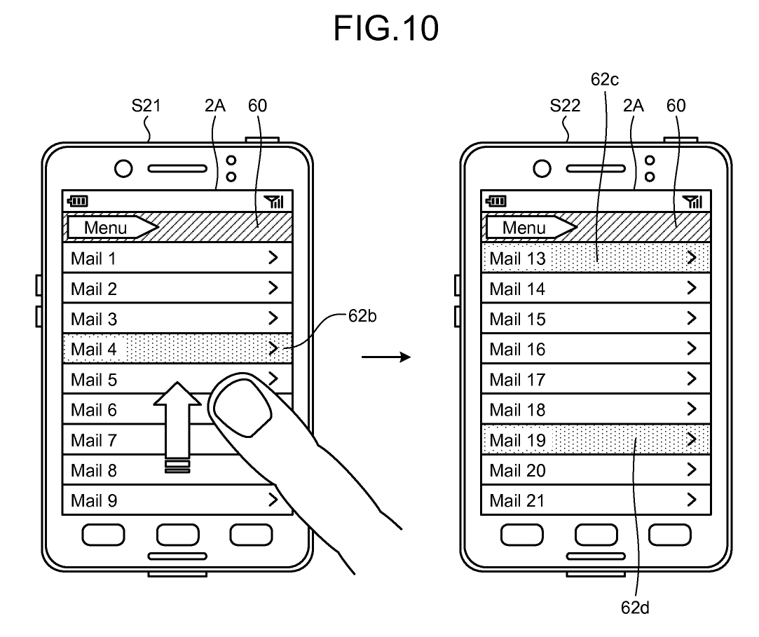

Referring to FIG. 9, the example has been explained in which the smartphone 1 controls the speed of scrolling the screen 60 so as to stop the item 62a of the unread mail currently displayed on the screen 60 at a specific position; however, the control of scrolling the screen is not limited thereto. For example, when an item 62 corresponding to a new unread mail appears on the screen 60 by scrolling the screen 60, the smartphone 1 may execute the same control as that illustrated in FIG. 9. Another example of the control will be explained below with reference to FIG. 10.

FIG. 10 represents another example of the control in a case where a scrolling operation is performed for the screen 60 while the screen 60 of the inbox is displayed on the display 2A. At Step S21, the inbox including an item 62b corresponding to an unread mail is displayed on the display 2A, and the user's right index finger touches the screen 60. At Step S22, the item 62b is moved to the outside of the display area of the screen 60 by scrolling the screen 60, and an item 62c and an item 62d corresponding to unread mails newly appear on the screen 60.

The smartphone 1 acquires a detection result of the touch screen 2B, and, when detecting an upward flick, scrolls the screen 60 of the inbox displayed on the display 2A. Subsequently, when the item 62c corresponding to the unread mail newly appears on the screen 60 by scrolling the screen 60, the smartphone 1 controls the speed of scrolling the screen 60 according to the setting conditions included in the setting data 9Z, for example, so as to display the item 62c at the top of the inbox. For example, the smartphone 1 stops the scrolling at a timing at which the item 62c corresponding to the unread mail reaches the top of the inbox. Alternatively, the smartphone 1 adjusts the initial speed of the scrolling and a decrease rate of the speed thereof so that the speed of the scrolling gradually decreases as the item 62c corresponding to the unread mail approaches the top of the inbox and becomes zero at the timing at which the item 62c reaches the top of the inbox.

As illustrated in FIG. 10, when detecting the flick performed for the screen 60, the smartphone 1 scrolls the screen 60 of the inbox. The smartphone 1 then stops scrolling when the item 62b corresponding to the unread mail that newly appears on the screen 60 reaches the top of the inbox through scrolling. That is, the smartphone 1 allows the user to change, with the user's simple touch gesture, the display position of the item 62 not currently displayed on the screen 60, among the items corresponding to unread mails to a position where the user can easily visually recognize the item 62. Thus, according to the present embodiment, it is possible not only to improve the operability of screen scrolling but also to reduce the possibility of overlooking the unread mail.

The control is not limited to the case in which the upward flick is detected. When a downward flick is detected, the smartphone 1 may control scrolling, for example, so as to stop the unread mail at the bottom of the inbox according to the setting conditions.

In the case illustrated in FIG. 10, when detecting a tap performed for the screen 60 during scrolling the screen 60 of the inbox, the smartphone 1 may stop scrolling the screen 60.

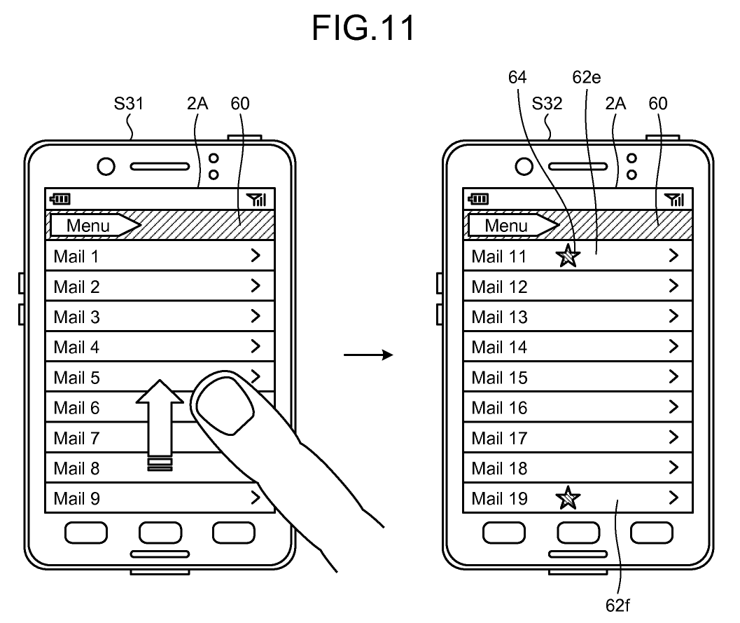

Referring to FIG. 9 and FIG. 10, the examples have been explained in which the smartphone 1 controls the scrolling so as to display the item corresponding to the unread mail at a specific position; however, the control of scrolling the screen is not limited thereto. For example, the smartphone 1 may execute the control for scrolling so as to display the item 62 attached with the mark 64 at a specific position. Another example of the control will be explained below with reference to FIG. 11.

FIG. 11 is another example of the control in a case where a screen scrolling operation is detected through the touch screen 2B while the screen 60 of the inbox is displayed on the display 2A. At Step S31, the screen 60 of the inbox including a plurality of items corresponding to read mails is displayed on the display 2A, and the user's right index finger touches the screen 60. At Step S32, the items 62 corresponding to the mails 1 to 10 are moved to the outside of the display area of the screen 60 by scrolling the screen 60, and an item 62e and an item 62f each of which is attached with the mark 64 newly appear on the screen 60.

The smartphone 1 acquires a detection result of the touch screen 2B, and, when detecting an upward flick, scrolls the screen 60 of the inbox displayed on the display 2A. Subsequently, when the item 62e attached with the mark 64 newly appears on the screen 60 of the inbox by scrolling the screen 60, the smartphone 1 controls the speed of the scrolling according to the setting conditions included in the setting data 9Z, for example, so as to display the item 62e at the top of the inbox. For example, the smartphone 1 stops the scrolling at a timing at which the item 62e attached with the mark 64 reaches the top of the inbox. Alternatively, the smartphone 1 adjusts the initial speed of the scrolling and a decrease rate of the speed thereof so that the speed of the scrolling gradually decreases as the item 62e attached with the mark 64 approaches the top of the inbox and becomes zero at the timing at which the item 62e reaches the top of the inbox.

As illustrated in FIG. 11, when detecting the flick performed for the screen 60, the smartphone 1 scrolls the screen 60 of the inbox. The smartphone 1 then stops scrolling when the item 62e including the mark 64 that newly appears on the screen 60 of the inbox reaches the top of the inbox through scrolling. That is, the smartphone 1 allows the user to change, with the user's simple touch gesture, the display position of an item corresponding to the mail attached with the mark 64 by the user, among the items 62 included in the inbox, to a position where the user can easily visually recognize the item. Thus, according to the present embodiment, it is possible to improve the operability of screen scrolling for not only an unread mail but also a mail selected by the user.

The control is not limited to the case illustrated in FIG. 11. When an upward flick is detected, the smartphone 1 may control scrolling, for example, so as to stop the item 62e including the mark 64 at the bottom of the inbox according to the setting conditions.

Referring to FIG. 11, the example has been explained in which the smartphone 1 stops scrolling so as to display the item 62e including the mark 64 that appears on the screen 60 of the inbox at the top of the inbox by scrolling the screen 60 of the inbox; however, the control of scrolling the screen is not limited thereto. For example, the smartphone 1 may stop scrolling the screen 60 when detecting a tap performed for the screen 60 during scrolling the screen 60.

When an item corresponding to the unread mail and an item including the mark 64 are included in the inbox, the smartphone 1 may control the item, which first appears in the inbox among the item corresponding to the unread mail and the item including the mark 64, so as to be displayed at the top of the inbox through scrolling. Alternatively, the smartphone 1 may control either one of the item corresponding to the unread mail and the item including the mark 64 so as to be displayed at the top of the inbox through scrolling.

In the cases illustrated in FIG. 9, FIG. 10, and FIG. 11, the smartphone 1 may control the scrolling so as to scroll the screen 60 and display a specific item included in the inbox at any specific position other than the top of the inbox. For example, the smartphone 1 may control the scrolling so as to display a specific item included in the inbox at the center of the inbox.

In the cases illustrated in FIG. 9, FIG. 10, and FIG. 11, the smartphone 1 may control the scrolling so as to display an item that corresponds to search criteria entered by the user at a specific position in the inbox. For example, the smartphone 1 displays a search-criteria entry screen on the display 2A and receives an entry of the search criteria from the user. When a flick is detected after the search-criteria entry screen is closed, the smartphone 1 scrolls the screen and stops the scrolling when the item corresponding to the search criteria reaches the specific position in the inbox. For example, the smartphone 1 may accept an entry of a mail address, a text included in the body of a mail, or the like, as the search criteria from the user.

Referring to FIG. 9, FIG. 10, and FIG. 11, the examples have been explained in which the smartphone 1 scrolls the screen 60 of the inbox and then stops scrolling so as to display a specific item 62 included in the inbox at a specific position in the inbox; however, the control of scrolling the screen is not limited thereto. For example, the smartphone 1 may scroll the screen 60 of the inbox and then decrease the speed of the scrolling as the specific item 62 included in the inbox approaches the specific position in the inbox.

Referring to FIG. 9, FIG. 10, and FIG. 11, the examples have been explained in which the smartphone 1 performs control when the scrolling operation is performed for the screen 60 during the display of the screen 60 of the inbox on the display 2A; however, the same control can be applied to any screen that includes a plurality of items. For example, the smartphone 1 can apply the same control to a screen that displays a list of items corresponding to text data recorded in a notepad, a screen that displays a list of items corresponding to downloaded applications, a screen that displays a list of address information included in an address book, and a screen that displays a list of items corresponding to bookmarked social network services. For example, the smartphone 1 may control the scrolling so as to scroll the screen that displays the list of the items included in the notepad and then to display an item previously selected by the user at a specific position on the screen. For example, the smartphone 1 may control the scrolling so as to scroll the screen that displays the list of the items corresponding to the applications and then to display an item corresponding to an application that requires update at a specific position on the screen. For example, the smartphone 1 may control the scrolling so as to scroll the screen that displays the list of the address information included in the address book and then to display an item corresponding to address information newly received through wireless communication such as infrared communication at a specific position on the screen. For example, the smartphone 1 may control the scrolling so as to scroll the screen that displays the list of the items corresponding to the bookmarked social network services and then to display an item corresponding to a social network service with updated information at a specific position on the screen.

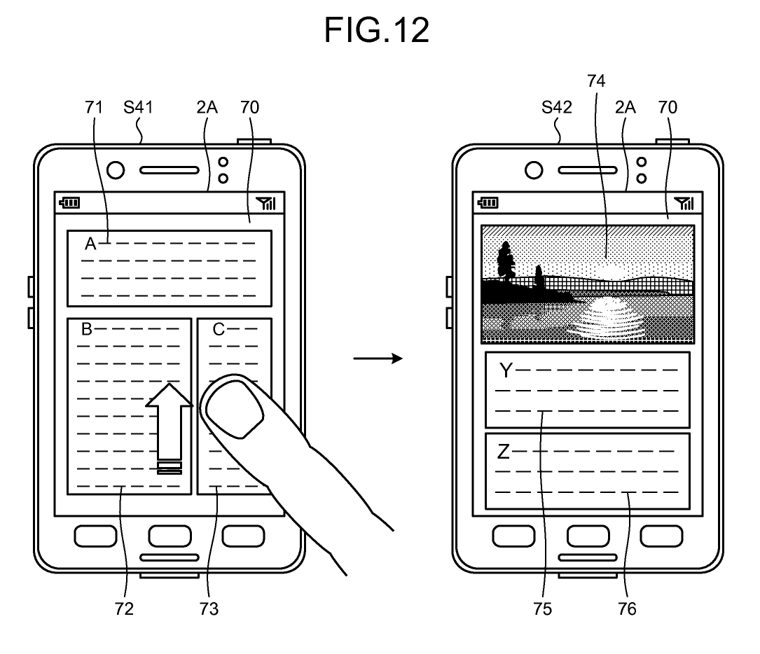

The control of scrolling the screen is not limited to the examples in which, as illustrated in FIG. 9, FIG. 10, and FIG. 11, the smartphone 1 controls the scrolling of the screen including a plurality of items. For example, the smartphone 1 may control the scrolling of the screen including a plurality of pieces of information whose attributes are different from each other, such as the screen of a WEB page including text data and image data. The smartphone 1 determines an attribute of the information included in the WEB page based on, for example, a type of a tag included in HTML data or a value of property (attribute) included in the tag. Another example of the control will be explained below with reference to FIG. 12.

FIG. 12 represents an example of control in a case where a scrolling operation is performed for the screen 70 while the screen 70 of the WEB page is displayed on the display 2A. At Step S41, the WEB page including the text data 71, the text data 72, and the text data 73 is displayed on the display 2A, and the user's right index finger touches the screen 70. At Step S42, the text data 71 to 73 are moved to the outside of the display area of the screen 70 by scrolling the screen 70, and the image data 74 and the text data 75 to 76 newly appear on the screen 70.

The smartphone 1 acquires a detection result of the touch screen 2B, and, when detecting an upward flick, scrolls the screen 70 of the WEB page displayed on the display 2A. Subsequently, when the image data 74, whose attribute is different from those of the text data 71 to 73 displayed on the display 2A at Step S41, appears on the screen 70 through scrolling, the smartphone 1 controls the speed of the scrolling so as to display the image data 74 at the top of the WEB page according to the setting conditions included in the setting data 9Z. For example, the smartphone 1 stops the scrolling at a timing at which the image data 74 reaches the top of the WEB page. Alternatively, the smartphone 1 adjusts the initial speed of the scrolling and a decrease rate of the speed thereof so that the speed of the scrolling gradually decreases as the image data 74 approaches the top of the WEB page and becomes zero at the timing at which the image data 74 reaches the top of the WEB page.

As illustrated in FIG. 12, when detecting the flick performed for the screen 70, the smartphone 1 scrolls the screen 70 of the WEB page. The smartphone 1 then stops scrolling when the image data 74 that newly appears on the screen 70 of the WEB page reaches the top of the WEB page through scrolling. That is, the smartphone 1 allows the user to change, with the user's simple touch gesture, the display position of specific data, among a plurality of data included in the WEB page, to a position where the user can easily visually recognize the specific data. Thus, according to the present embodiment, it is possible to improve the operability of screen scrolling.

The control is not limited to the case illustrated in FIG. 12. For example, when an upward flick is detected, the smartphone 1 may scroll the screen 70 and then stop scrolling, for example, so as to stop the image data 74 at the bottom of the WEB page according to the setting conditions.

The control is not limited to the case illustrated in FIG. 12. For example, the smartphone 1 may scroll the screen 70 of the WEB page and then decrease the speed of the scrolling as the image data 74 included in the WEB page approaches a specific position in the WEB page. In this case, the smartphone 1 continues to scroll without stopping the scrolling even when the image data 74 reaches the top of the WEB page. By decreasing the speed of the scrolling more than usual when displaying the image data 74 or the neighborhood thereof, the smartphone 1 can make the image data 74 easy to be found.

Referring to FIG. 12, the example has been explained in which the smartphone 1 stops scrolling so as to display the image data 74 that appears on the screen 70 of the WEB page at the top of the WEB page by scrolling the screen 70; however, the control of scrolling the screen is not limited thereto. For example, the smartphone 1 may stop scrolling the screen 70 when detecting a tap performed for the screen 70 during scrolling the screen 70.

In the case illustrated in FIG. 12, the smartphone 1 may control the scrolling so as to display the image data 74 at the center of the WEB page instead of at the top of the WEB page.

In the case illustrated in FIG. 12, the scrolling may be controlled so as to display text data including a specific character string, instead of the image data 74, at a specific position in the WEB page. For example, the smartphone 1 may control the scrolling so as to display the text data including a specific character string at a specific position in the WEB page.

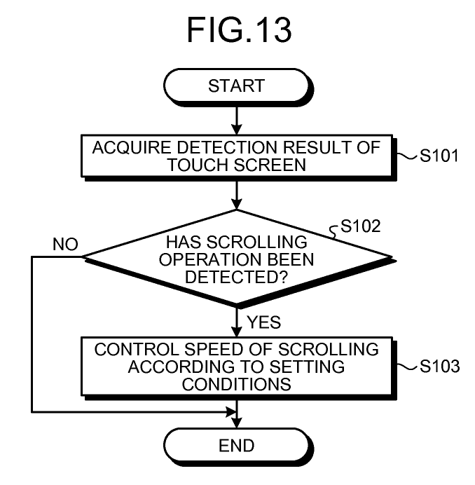

An example of a control procedure based on the function provided by the control program 9A will be explained below with reference to FIG. 13. FIG. 13 represents a procedure for controlling the speed of scrolling the screen according to an attribute of information displayed on the display 2A in a case where a screen scrolling operation is detected through the touch screen 2B. The procedure illustrated in FIG. 13 is implemented by the controller 10 executing the control program 9A. The procedure illustrated in FIG. 13 is repeatedly executed by the controller 10 while a plurality of pieces of information are displayed on the display 2A.

As illustrated in FIG. 13, at Step S101, the controller 10 acquires a detection result of the touch screen. Subsequently, at Step S102, the controller 10 determines whether a scrolling operation has been detected. For example, the controller 10 determines whether an upward flick or a downward flick has been detected.

When a scrolling operation has been detected as a result of determination (Yes at Step S102), then at Step S103, the controller 10 controls the speed of the scrolling according to the setting conditions, and ends the process. Specifically, the smartphone 1 determines whether the attribute of information displayed on the display 2A corresponds to the setting conditions. When the information displayed on the display corresponds to the setting conditions as a result of determination, the smartphone 1 adjusts the speed of the scrolling. Meanwhile, when the information displayed on the display does not correspond to the setting conditions, the smartphone 1 does not adjust the speed of the scrolling. For example, when the control of scrolling the screen is set as the setting conditions, in the smartphone 1, so as to display an item corresponding to the unread mail at a specific position in the inbox, the controller 10 stops the scrolling, for example, when an item corresponding to the unread mail newly appearing on the screen reaches a specific position in the inbox by the scrolling. Alternatively, the controller 10 decreases the speed of the scrolling as the item corresponding to the unread mail approaches the specific position in the inbox, and stops the scrolling at a timing at which the item corresponding to the unread mail reaches the specific position in the inbox. When the setting conditions are set such that a piece of information, which is included in a WEB page and differs from other pieces of information in the attribute thereof, is displayed at specific positions, the controller 10 stops the scrolling, for example, when the image data newly appearing on the screen reaches at the specific position of the WEB page through scrolling. Alternatively, the controller 10 decreases the speed of the scrolling as the image data approaches the specific position in the WEB page, and stops scrolling at the timing at which the image data reaches the specific position in the WEB page.

The embodiment disclosed in the present application can be modified without departing the gist and the scope of the invention. Moreover, the embodiments and their modifications disclosed in the present application can be combined with each other if necessary. For example, the embodiment may be modified as follows.

For example, the programs illustrated in FIG. 5 may be divided into a plurality of modules, or may be combined with any other program.

In the embodiment, the smartphone has been explained as an example of the device provided with the touch screen; however, the device according to the appended claims is not limited to the smartphone. The device according to the appended claims may be a mobile electronic device other than the smartphone. Examples of the mobile electronic devices include, but are not limited to, mobile phones, tablets, mobile personal computers, digital cameras, media players, electronic book readers, navigators, and gaming devices. The device according to the appended claims may be a stationary-type electronic device. Examples of the stationary-type electronic devices include, but are not limited to, desktop personal computers, automatic teller machines (ATM), and television receivers.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A device comprising:
a touch screen display for displaying a screen including a plurality of pieces of information; and
a controller for controlling, upon scrolling the screen, speed of scrolling the screen according to an attribute of the piece of the information displayed on the touch screen display.

2. The device according to claim 1, wherein
the touch screen display is configured to display the screen including a list of a plurality of items, each of items corresponding to one of the pieces of the information, and
the controller is configured to
scroll the screen, and then
stop the scrolling when a first item corresponding to a first piece of the information reaches a specific position on the touch screen display, the first piece of the information having a first attribute.

3. The device according to claim 2, wherein
the controller is configured to accept input of search criteria, and
the first attribute is an attribute that corresponds to the input search criteria.

4. The device according to claim 2, wherein
the first attribute is an attribute indicating that the corresponding piece of the information is unread by a user.

5. The device according to claim 2, wherein
the first attribute is an attribute indicating that the corresponding piece of the information is previously selected.

6. The device according to claim 1, wherein
the touch screen display is configured to display the screen including a list of a plurality of items, each of items corresponding to one of the pieces of the information, and
the controller is configured to
scroll the screen, and then
decrease speed of the scrolling as a second item corresponding to a second piece of the information approaches a specific position on the touch screen display, the second piece of the information having a second attribute.

7. The device according to claim 6, wherein
the controller is configured to accept input of search criteria, and
the second attribute is an attribute that corresponds to the input search criteria.

8. The device according to claim 6, wherein
the second attribute is an attribute indicating that the corresponding piece of the information is unread by a user.

9. The device according to claim 6, wherein
the second attribute is an attribute indicating that the corresponding piece of the information is previously selected.

10. The device according to claim 1, wherein
the touch screen display is configured to display the screen including the plurality of the pieces of the information each having an attribute, and
the controller is configured to
scroll the screen, and then
stop the scrolling when a third piece of the information having a third attribute reaches a specific position on the touch screen display.

11. The device according to claim 1, wherein
the touch screen display is configured to display the screen including the plurality of the pieces of the information each having an attribute, and
the controller is configured to
scroll the screen, and then
decrease speed of the scrolling as a fourth piece of the information having a fourth attribute approaches a specific position on the touch screen display.

12. A method for controlling a device having a touch screen display, the method comprising:
displaying a screen including a plurality of pieces of information on the touch screen display; and
controlling, upon scrolling the screen, speed of scrolling the screen according to an attribute of the piece of information displayed on the touch screen display.

13. A non-transitory storage medium that stores a program for causing, when executed by a device having a touch screen display, the device to execute:
displaying a screen including a plurality of pieces of information on the touch screen display; and
controlling, upon scrolling the screen, speed of scrolling the screen according to an attribute of the piece of information displayed on the touch screen display.
